(19) United States
(12) Patent Application Publication
(10) Pub. No.: US 2012/0244263 A1
(43) Pub. Date: Sep. 27, 2012

(54) REDUCED SODIUM SALT COMPOSITION

(75) Inventors: Richard Durno MURRAY, Wyong NSW (AU); Kim WOOLLETT, Epping NSW (AU)

(73) Assignee: The Smith's Snackfood Company Limited, Chatswood (AU)

(21) Appl. No.: 13/069,040

(22) Filed: Mar. 22, 2011

(51) Int. Cl. A23L 1/237; A23P 1/08; A23L 1/307

(52) U.S. Cl. 426/292; 426/649; 426/519; 426/289

(57) ABSTRACT

The invention allows for a reduction in the amount of sodium chloride applied to a food product, without adversely affecting the taste of the food product. Sodium chloride particles with bi-modal particle size distribution are combined with particles of another edible salt with a particle size distribution peak that falls between the bi-modal peaks of the sodium chloride particles. In this way, any off-flavors exhibited by the other edible salt are masked by the initial and final pure sodium chloride saltiness flavors provided by the composition.

### BACKGROUND OF THE INVENTION

1. Technical Field

The present invention is directed to a salt composition, a method of choosing a salt composition, a salted food product, and a method of salting a food product.

2. Description of Related Art

Salt is a popular seasoning for food products. Salt typically comprises sodium chloride crystals, but can further comprise other mineral salts.

Although salt is a popular and effective seasoning, in recent years, some consumers have expressed a preference for food products that have reduced levels of sodium. Research in the area of sodium reduction has focused primarily on two areas. First, some researchers have investigated reducing the size of salt particles applied to food. U.S. Patent Publication No 20080008790 alleges that using salt particle sizes less than 20 microns increases the perception of saltiness on the part of consumers, thereby allowing practitioners to reduce the overall amount of salt applied to food products without diminishing the overall level of saltiness perceived by the consumer. The second area of research is directed to substituting compounds that do not contain sodium for sodium chloride in salt compositions. These substitute compounds attempt to mimic the taste of sodium chloride, but frequently suffer from off-flavors that can be detected by consumers.

A need still exists in the art for a way of reducing the amount of sodium chloride in salted food products without the consumer perceiving a meaningful loss in salt flavor, or otherwise adversely affecting the flavor of the salted food.

### SUMMARY OF THE INVENTION

The present invention is directed to a salt composition, salted food product, a method of choosing a salt composition, and a method for salting a food product. In one embodiment, the salt composition comprises sodium chloride particles having a bi-modal peak particle size distribution, and at least one edible salt other than sodium chloride (such as potassium chloride, calcium chloride, magnesium chloride, magnesium sulfate, and potassium sulfate) having a peak particle size distribution that lies between the two peaks of the bi-modal peak size.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying figures, wherein:

FIG. 1 depicts the saltiness perception over time for two different sodium chloride compositions;

FIG. 2 depicts the saltiness perception of one embodiment of the inventive salt composition;

FIG. 3 depicts a salt composition with bi-modal particle size distribution peaks.

### DETAILED DESCRIPTION OF THE INVENTION

The present invention is thus directed to methods and salt compositions that can be used to provide a salted food product with reduced levels of sodium chloride, but without the consumer perceiving a meaningful loss in salty flavor or meaningful increase in off-flavors. The inventive composition combines sodium chloride, which almost universally provides a salty flavor with no metallic, bitter or otherwise objectionable off-flavors, with at least one edible salt other than sodium chloride, which some tasters describe as having such metallic, bitter or other off-flavors. The inventors herein have determined that any off-flavors exhibited by particles of edible salts other than sodium chloride can be effectively masked by combining them with larger and smaller particles of sodium chloride, which has not been recognized in the art, as described in detail below.

Although the exact mechanism of salty taste perception in the human mouth is not fully understood, experts agree that salt must be dissolved (or dissociated into its constituent ions) before it can stimulate the salty taste receptors inside the mouth. Therefore, a salt applied to a food product that dissolves more quickly into solution will be perceived as salty more quickly than a salt that dissolves more slowly into solution. The salty taste receptors are also able to detect changes in concentration of salt in solution, with more concentrated solutions being perceived as having a higher salty flavor intensity.

The dissolution rate for a solid edible salt particle into aqueous solution is dependent on several factors, including solubility, but one of the main factors is the extent of the interaction between the solid surface and the liquid. The dissolution rate of most edible salts is related to the rate of the surface reaction. This means that providing more surface area per weight for a given edible salt will increase the dissolution rate of the salt.

One way to increase the surface area per weight of salt is to decrease the size of the salt particles. Assuming a cubic salt crystal shape of a given density, halving the particle size of a given weight of salt will result in a doubling of the surface area per weight of salt. Conversely, the surface area per weight of a salt can be decreased by increasing the size of the salt particles. The inventors herein do not assume that every edible salt has a cubic crystal shape, and this invention is not based on such an assumption. The cubic crystal shape is merely offered to demonstrate the principle that, for any given salt, decreasing the particle size will increase the surface area per weight, and increasing the particle size will decrease the surface area per weight. In other words, the surface area per weight for a given salt is inversely related to the particle size. Again, an increase of the surface area per weight of a salt will result in an increase in dissolution rate, while a decrease in the surface area per weight will result in a decrease in dissolution rate.

While there are other ways to modify the surface area per weight of a salt, such as by altering the physical structure of the salt, it is extremely difficult to directly measure the surface area of a salt composition and use it to determine the surface area per weight. However, instead of using direct measurement, the inverse relationship between particle size and surface area per weight allows a practitioner of the present invention to reasonably approximate the surface area per weight, and therefore the dissolution rate, of different salt compounds. As such, the dissolution rate of 200 micron sodium chloride particles is expected to be approximately equivalent to the dissolution rate of 200 micron potassium chloride particles. Similarly, the dissolution rate of 100 micron potassium chloride will be faster than 200 micron sodium chloride, but slower than 10 micron sodium chloride.

The dissolution rate of a salt is important to saltiness perception because, as described above, the salt taste receptors in the human mouth only perceive dissolved salt ions, and moreover, are able to perceive differences in concentration of those ions in solution. Therefore, a smaller salt particle with a higher dissolution rate will rapidly increase the salt concentration in saliva in the areas around the salty taste receptors, which will cause the receptors to perceive the salt as initially saltier tasting than a salt with a lower dissolution rate. However, the dissolved salt will also rapidly diffuse into saliva present in the mouth away from salty taste receptors due to the motion caused by mastication and generally high diffusion rate of the ions present in edible salts. This rapid diffusion of salt ions results in a rapid decline in saltiness perception following the initially high level of saltiness perception. By contrast, a larger salt particle with a slower dissolution rate will cause a slower increase in salt concentration around the salty taste receptors, but will maintain that concentration for a longer period of time than the smaller salt particle, resulting in a slower but extended saltiness taste perception. Some larger salt particles may even be swallowed before dissolving completely, depending on how long the food product is chewed.

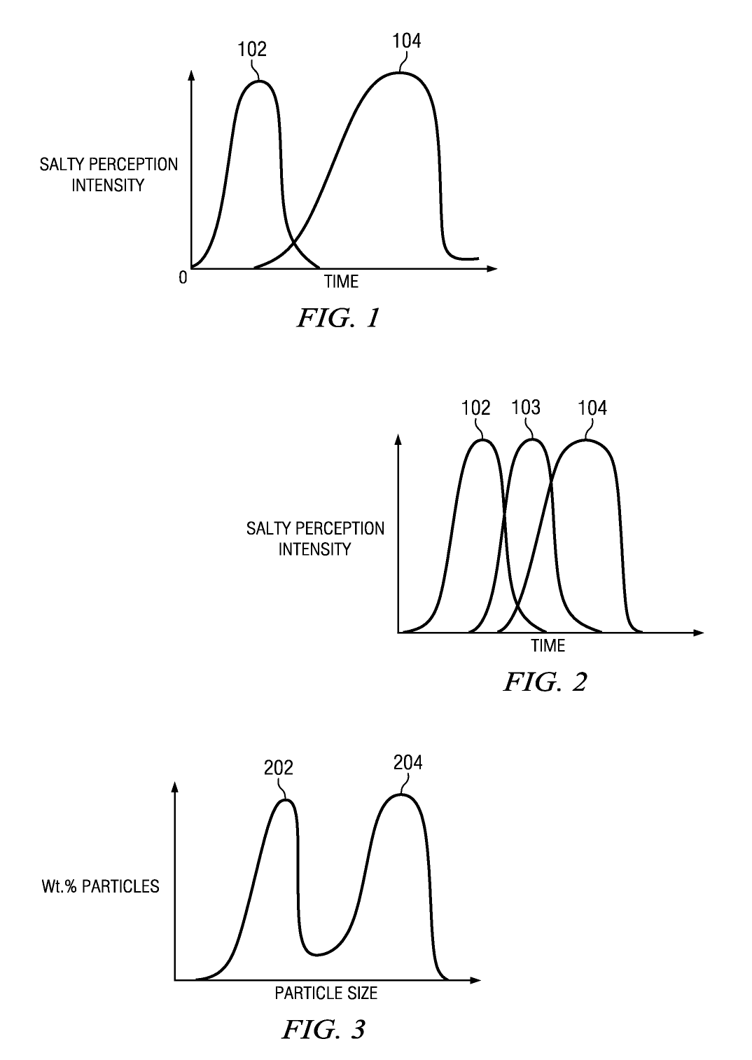

This principle is illustrated graphically in FIG. 1. FIG. 1 is a theoretical graph comparing the intensity of the saltiness perception over time for a given weight of salt particles having two different particle sizes. The curve for particles having a smaller particle size is represented by 102, and the curve for particles having a larger particle size is represented by 104. As can be seen, the smaller particle size salt curve 102 is perceived more quickly and more intensely than 104, but does not extend the saltiness perception for as long a period of time as 104. Importantly, there can be some overlap in the saltiness perception curves, as illustrated in FIG. 1. A composite saltiness perception curve for a mixture of the particles represented by 102 and 104 would have a similar shape, with two intensity peaks separated by a valley. Depending on the particle sizes chosen, there can be substantial overlap of the saltiness perception curves, even to the point that they appear to be a single curve. A smaller salt particle can be used to bring the saltiness intensity up quickly to a high level, and a larger salt particle can be used to extend the saltiness perception for an acceptable period of time. Other combinations are also possible.

Salt compositions currently available in the market can be purchased according to particle size distributions. For example, a salt composition can be purchased that has a weighted mean particle size of 220 microns, wherein the particle sizes range from 10 microns to 600 microns, with a peak at 220 microns. In some salt compositions, the distribution of the particles surrounding the peak can follow an approximately Gaussian or normal distribution. In other words, very few salt particles would have particle sizes of around 10 or around 600 microns, while a relatively large number of salt particles would have a particle size of about 220 microns. Salt compositions can also be purchased with relatively tight or loose particle size distributions and ranges, depending on the intended application of the salt composition.

The inventive composition herein is a combination of salt particles which are chosen according to particle size. In one embodiment, the inventive composition is a combination of sodium chloride and at least one edible salt other than sodium chloride, wherein the particle size distribution of the sodium chloride particles is bi-modal, and the other edible salt exhibits mono-modal distribution. In this embodiment, the particle size peak of the other edible salt falls between the particle sizes associated with each of the bi-modal peaks of the sodium chloride particles. The inventive composition provides superior saltiness flavor over prior art compositions because the salty taste receptors receive the following flavor profile: an initial, intense pure sodium chloride saltiness perception provided by the small particle size sodium chloride, followed by a saltiness perception similar to sodium chloride provided by the intermediately sized other edible salt, concluded by a pure sodium chloride saltiness perception provided by the large particle sized sodium chloride. In this way, any off-flavors exhibited by the other edible salt are masked by the initial and final pure sodium chloride salty perception. This principle has been experimentally verified, as described in more detail in the Examples section.

FIG. 2 is a graphical depiction of the salty flavor profile of the inventive composition. Curves 102 and 104 illustrate the saltiness perception of the small and large sodium chloride particles, respectively. Curve 103 illustrates the saltiness perception of the other edible salt having an intermediate particle size. The inventive composition will, therefore, be perceived as an almost continuously pure sodium chloride saltiness.

FIG. 3 depicts the particle size distribution for a theoretical composition of sodium chloride particles having bi-modal distribution with peaks 202 and 204. The particle size distribution shown in FIG. 3 is in weight percent versus particle size, which is the preferred measure of particle size distribution because it is relatively easy to measure through sieve analysis. However, particle size distribution curves based on volume or weighted volume (which can be determined by laser diffraction analysis, or other methods known in the art) are expected to have a similar profile, and are believed to function on principles similar to those that govern the inventive composition disclosed and claimed herein. As used herein, when a composition is said to have a particle size distribution with a peak at a particular particle size (or particular particle sizes), a plot or graph of particle size (x) versus weight percent of particles (y) on an x-y axis will show at least one peak (exactly two, in the case of FIG. 3).

A group of sodium chloride particles can be given bi-modal distribution in a number of ways. For example, two different mono-modal sodium chloride compositions can be combined into a single composition. As long as the peak particle sizes of each composition are far enough apart, or the peaks for each composition are sharp enough, that substantial overlap in particles between each peak particle size does not occur, the resulting composition will have a bi-modal particle size distribution similar to that shown in FIG. 3. As stated above, mono-modal sodium chloride compositions are commercially available. A second way to produce a sodium chloride composition with bi-modal particle size peak distribution is to use separation processes (e.g. sieving, filtering) on a mono-modal or random salt composition to remove at least one particle size fraction and produce a desired bi-modal distribution. This method may provide a practitioner with a high level of control over the final particle size distribution, but may also result in unacceptable amounts of waste, depending on whether the waste portion of salt may be put to other uses. Combinations of these methods or other methods may also be used, as determined by one skilled in the art after reading the teachings contained herein.

The inventive composition allows a practitioner to lower the level of sodium chloride, and therefore the level of sodium, applied to salted food products without adversely affecting the salty flavor of the food. It also allows a practitioner to provide a different nutritional profile in a salt composition applied to a food product without adversely affecting flavor. The different nutritional profile is provided by salts that utilize ions other than sodium, which the human body needs in order to function.

In one embodiment, the edible salt other than sodium chloride is an edible inorganic salt with a cation selected from the group consisting of alkali metal ions (other than Na⁺, and preferably consisting of K⁺), earth alkali ions (preferably Mg²⁺ or Ca²⁺), and polyatomic cations (preferably ammonium), or an anion selected from the group consisting of phosphates (preferably monophosphates: PO₄³⁻, HPO₄²⁻, H₂PO₄⁻), sulfates (SO₄²⁻), halogenides (preferably Cl⁻), carbonates or hydrogen carbonates. Preferred examples of edible salts other than sodium chloride that could be used with the present invention include ammonium chloride, potassium chloride, calcium chloride, magnesium chloride, magnesium sulfate, and potassium sulfate. Any salts actually included in a food product according to the present invention should be food-safe and applied in accordance with any applicable laws, regulations and standards relating to food safety.

The table below contains the solubility (given in grams of salt per 100 grams of water at 1 atmosphere of pressure) of sodium chloride and several other edible salts.

TABLE 1
Solubility of Edible Salts (g salt/100 g water at 1 atm)

| Edible Salt | Solubility @ 30° C. | Solubility @ 40° C. |
|---|---|---|
| Sodium chloride | 36.09 | 36.37 |
| Potassium chloride | 37.2 | 40.1 |
| Magnesium chloride | 55.8 | 57.5 |
| Calcium chloride | 100 | 128 |
| Ammonium chloride | 41.4 | 45.8 |
| Potassium sulfate | 13 | 14.8 |
| Magnesium sulfate | 38.9 | 44.5 |
| Calcium sulfate | 0.264 | 0.265 |
| Ammonium bicarbonate | 28.4 | 36.6 |
| Potassium carbonate | | |
| KCO₃ | 114 | 117 |
| KHCO₃ | 39.9 | 47.5 |
| Ammonium phosphates | | |
| NH₄H₂PO₄ | 46.4 | 56.7 |
| (NH₄)₂PO₄ | 75.1 | 81.8 |
| Potassium phosphates | | |
| KH₂PO₄ | 28 | 35.5 |
| K₃PO₄ | 108 | 133 |

Calcium sulfate is not included in the list of preferred edible salts to be used with the present invention due to its low water solubility at temperatures similar to the human mouth. However, the remainder of edible salts listed in Table 1 could be used as the non-NaCl edible salt in the inventive composition disclosed herein.

### Examples

In a first set of tests, five different samples of potato chips were salted with salt compositions and taste tested, as described below.

A first potato chip sample (the control) was salted at a level of 1.3% by weight with a first control pure sodium chloride composition having a mean particle size of 220 microns. (It should be noted that whenever “pure” sodium chloride or potassium chloride is referred to throughout this document, it is understood by one skilled in the art that minor constituents may be included, such as minor impurities from the manufacturing process, or flowability or anti-caking agents that do not materially affect the taste.)

A second potato chip sample was salted at a level of 1.3% by weight with a second pure sodium chloride composition having a mean particle size of 15 microns.

A third potato chip sample was salted at a level of 1.3% by weight with a first pure potassium chloride composition having a mean particle size of about 250 microns.

A fourth potato chip sample was salted at a level of 1.3% by weight with a second potassium chloride composition comprising a mixture of around 35% pure potassium chloride with a particle size of about 75 microns and 65% pure sodium chloride having a mean particle size of around 220 microns

A fifth potato chip sample was salted at a level of 1.3% by weight with an inventive salt composition that was a mixture of equal weight proportions of the first and second sodium chloride compositions, and the second potassium chloride composition. Therefore, the inventive composition had bi-modal particle size distribution for sodium chloride, with particle size peaks for sodium chloride at 220 microns and 15 microns, and a mono-modal particle size peak for potassium chloride at 75 microns. The inventive composition had 33% less sodium than the control sodium chloride composition.

When the first potato chip sample was taste tested, the testers described it as a clean salt taste with an even profile, good impact and longevity. When the second potato chip sample was tested, the testers described it as a clean taste with strong initial impact, but less prolonged salt taste when compared with the first sample. When the third potato chip sample was tested, the testers described it as a sharp salty taste with strong, long lasting bitter/metallic taste. When the fourth potato chip sample was tested, the testers described it as a very sharp initial salty taste with a bitter/metallic taste that dissipated much more quickly than the third sample. When the fifth (inventive) potato chip sample was tested, the testers described it as having a strong initial saltiness impact and an aftertaste of sodium chloride, but having no obvious bitter/metallic taste. The testers did notice a subtle difference between the salty taste of the inventive sample and the first control sample, which was difficult to describe.

In a second set of tests, three different samples of potato chips were salted with salt compositions and taste tested, as described below.

A first potato chip sample (the control sample) was salted with pure sodium chloride having a mean particle size of 220 microns, at a level of 1.3% by weight. A second potato chip sample was salted with pure sodium chloride having a mean particle size of about 15 microns at a level of 1.105% by weight.

A third potato chip sample was salted with the inventive composition used in the fifth potato chip sample described with respect to the first set of tests above, at a level of 1.2% by weight. Therefore, the third potato chip sample contained about 0.8% sodium chloride by weight.

The three samples in the second set of tests were subjected to more rigorous analyses than were used in the first set of tests. The taste testers conducted blind taste tests of the control, second test, and third test samples, comparing them for liking and attribute strength. The testers liked the third potato chip sample more than the control sample in terms of appearance and overall flavor, but did not show a statistically significant preference for either sample. The testers also showed no statistically significant difference in liking the aftertaste of the control and third sample. The comments of the testers showed that the differentiation on the basis of overall taste was due to a stronger salty impact and stronger salty flavor perceived in the third sample, and neither sample was described as bitter. The testers did not demonstrate any statistically significant difference between the second sample and the control sample in terms of liking or preference. The comments regarding the second sample showed that the second sample was slightly blander than the control sample, but not enough to generate a difference in appeal.

The foregoing examples show that the off-flavors associated with edible salts other than sodium chloride can be masked by carefully controlling the particle size distribution of the edible salts in a composition with sodium chloride. If the particle size peak for the edible salt falls between the peaks of a bi-modal particle size distribution of sodium chloride particles, the initial and final pure sodium chloride salty taste can reduce or eliminate any off-flavors associated with the edible salt.

Applicants have also conducted similar taste tests on potato chips that have been seasoned with a seasoning composition that typically includes salt plus other flavors (such as cheese, vinegar, or barbeque flavors). The control samples in these tests used pure sodium chloride as the salt component of the seasoning composition, and the test samples used the inventive composition described herein as the salt component of the seasoning composition. Applicants believe, based on these tests, that the inventive salt composition can be used as a salt replacer in seasoning applications with similar effectiveness.

Thus, applicants herein have discovered a salt composition, method of choosing a salt composition, salted food product, and method of salting a food product.

In one embodiment, a salt composition comprises a plurality of sodium chloride particles having a bi-modal particle size distribution with a first peak at a first particle size and a second peak at a second particle size, wherein said first particle size is smaller than said second particle size; and a plurality of particles of at least one edible salt other than sodium chloride, having a particle size distribution comprising a third peak at a third particle size, wherein said third particle size is greater than said first particle size and smaller than said second particle size. In another embodiment, the salt composition consists essentially of the foregoing salt particles.

In one embodiment, a method of choosing a salt composition comprises providing a first salt comprising a plurality of sodium chloride particles having a particle size distribution with a first peak at a first particle size; providing a second salt comprising a plurality of sodium chloride particles having a particle size distribution with a second peak at a second particle size which is larger than said first particle size; providing a third salt comprising a plurality of particles of at least one edible salt other than sodium chloride having a particle size distribution with a third peak at a third particle size, which is larger than said first particle size and smaller than said second particle size; and combining said first, second and third salts at a predetermined weight ratio to produce said salt composition. In another embodiment, the method of choosing a salt composition comprises providing a first salt comprising a plurality of sodium chloride particles having bi-modal particle size distribution, with a first peak at a first particle size and second peak at a second particle size, which is larger than said first particle size; providing a third salt comprising a plurality of particles of at least one edible salt other than sodium chloride having a particle size distribution with a third peak at a third particle size, which is larger than said first particle size and smaller than said second particle size; and combining said first, and third salts at a predetermined weight ratio to produce said salt composition.

The predetermined weight ratio can be readily determined by one skilled in the art, after reading and considering the teachings herein, without undue experimentation. One example of a preferred weight ratio of large sodium chloride:intermediate edible salt:small sodium chloride is about 1:1:1. However, other weight ratios are within the scope of the present invention, and will depend on the solubility, dissolution rate, and the strength of salty flavor and off-flavors present in the individual edible salts used in conjunction with sodium chloride.

Similarly, the exact particle sizes used can be readily determined by one skilled in the art, after reading and considering the teachings herein, without undue experimentation. One example of a preferred particle size distribution is a composition with sodium chloride particle size peaks at 15 microns and 220 microns, and an edible salt peak at 75 microns. However, other particle size distributions are within the scope of the present invention, and will depend on the solubility, dissolution rate, and the strength of salty flavor and off-flavors present in the individual edible salts used in conjunction with sodium chloride.

Thus, one skilled in the art can tailor the particle size distribution and salt weight ratios for each combination of sodium chloride and other edible salts. For example, if the edible salt used in the inventive composition is slightly less soluble or has a lower dissolution rate than potassium chloride, one skilled in the art could reduce the particle size of the edible salt (while still keeping it between the large and small sodium chloride particle size peaks) to ensure it is dissolved and perceived between the small and large sodium chloride particles. On the other hand, if the edible salt is slightly more soluble or has a higher dissolution rate than potassium chloride, one skilled in the art could increase the particle size of the edible salt (while still keeping it between the large and small sodium chloride particle size peaks) to ensure it is dissolved and perceived between the small and large sodium chloride particles.

In one embodiment, the mono-modal non-sodium chloride edible salt fraction of the inventive composition is a combination of more than one edible salt. Combinations of edible salts can be employed to minimize the off-flavors associated with any one particular edible salt other than sodium chloride. If two edible salts are used for the intermediately-sized fraction in the inventive composition, up to half as much of each type of salt can be employed, thereby potentially reducing the off-flavors of each salt.

In another embodiment, a method of seasoning a food product comprises providing a food product and applying the salt composition of the present invention to the food product. In one embodiment, the sodium chloride and other edible salt are combined before being applied to the food product. In another embodiment, the sodium chloride and other edible salt are applied to the food product in separate steps. For example, in one embodiment, a bi-modal sodium chloride composition and a mono-modal edible salt composition can be applied to the food product as separate first and second steps. In another embodiment, a first mono-modal sodium chloride composition, a second mono-modal sodium chloride composition, and a third mono-modal edible salt composition can be applied to the food product in separate first, second and third steps. In still another embodiment, a first bi-modal composition comprising sodium chloride and another edible salt, and a second mono-modal composition comprising sodium chloride can be applied to the food product in separate first and second steps.

The present invention is a surprising improvement on the prior art because the amount of sodium applied to a food product can be reduced by at least 33% with no meaningful difference in saltiness perception by the consumer, and no meaningful perception of off-flavors associated with edible salts other than sodium chloride. This sodium reduction strategy can be coupled with other sodium reduction strategies to synergistically reduce the levels of sodium present in topically seasoned food products.

While the invention has been particularly shown and described with reference to several preferred embodiments, it will be understood by those skilled in the art that various changes in form and detail may be made therein without departing from the spirit and scope of the invention.

We claim:

1. A salt composition for application to a food product, said composition comprising:
a plurality of particles of sodium chloride having a bi-modal particle size distribution with a first peak at a first particle size and a second peak at a second particle size, wherein said first particle size is smaller than said second particle size; and
a plurality of particles of at least one edible salt other than sodium chloride, having a particle size distribution comprising a third peak at a third particle size, wherein said third particle size is greater than said first particle size and smaller than said second particle size.

2. The composition of claim 1 wherein said at least one edible salt comprises at least one of ammonium chloride, potassium chloride, calcium chloride, magnesium chloride, magnesium sulfate, and potassium sulfate.

3. The composition of claim 1 wherein said edible salt comprises potassium chloride.

4. The composition of claim 3 wherein said potassium chloride comprises about 33% by weight of the salt composition.

5. The composition of claim 3 wherein said first particle size is about 15 microns, said second particle size is about 220 microns, and said third particle size is about 75 microns.

6. The composition of claim 1 wherein said at least one edible salt comprises at least two edible salts other than sodium chloride.

7. A method of making a salt composition comprising:
combining particles of sodium chloride with particles of at least one edible salt other than sodium chloride, to produce a composition comprising:
a plurality of sodium chloride particles having a bi-modal particle size distribution with a first peak at a first particle size and a second peak at a second particle size, wherein said first particle size is smaller than said second particle size; and
a plurality of particles of at least one edible salt other than sodium chloride, having a particle size distribution comprising a third peak at a third particle size, wherein said third particle size is greater than said first particle size and smaller than said second particle size.

8. The method of claim 7 further comprising:
providing a plurality of particles of sodium chloride having said bi-modal particle size distribution;
providing a plurality of particles of at least one edible salt other than sodium chloride having said third peak at said third particle size.

9. The method of claim 7 further comprising:
providing a plurality of particles of sodium chloride having said first peak at said first particle size;
providing a plurality of particles of sodium chloride having said second peak at said second particle size;
providing a plurality of particles of said at least one edible salt other than sodium chloride having said third peak at said third particle size.

10. The method of claim 8 wherein said providing said plurality of sodium chloride particles comprises removing at least one particle size fraction of sodium chloride particles from a mixture of sodium chloride particles having random or mono-modal particle size distribution to produce said bi-modal particle size distribution.

11. The method of claim 7 wherein said at least one edible salt comprises at least one of ammonium chloride, potassium chloride, calcium chloride, magnesium chloride, magnesium sulfate, and potassium sulfate.

12. The method of claim 7 wherein said edible salt comprises potassium chloride.

13. The method of claim 12 wherein said potassium chloride comprises about 33% by weight of the salt composition.

14. The method of claim 7 wherein said first particle size is about 15 microns, said second particle size is about 220 microns, and said third particle size is about 75 microns.

15. A food product comprising:
a salt composition comprising a plurality of particles of sodium chloride having a bi-modal particle size distribution with a first peak at a first particle size and a second peak at a second particle size, wherein said first particle size is smaller than said second particle size; and a plurality of particles of at least one edible salt other than sodium chloride, having a particle size distribution comprising a third peak at a third particle size, wherein said third particle size is greater than said first particle size and smaller than said second particle size.

16. The food product of claim 15 further comprising about 1.3% by weight said salt composition.

17. The food product of claim 15 wherein said at least one edible salt comprises at least one of ammonium chloride, potassium chloride, calcium chloride, magnesium chloride, magnesium sulfate, and potassium sulfate.

18. The food product of claim 15 wherein said edible salt comprises potassium chloride.

19. The food product of claim 18 wherein said potassium chloride comprises about 33% by weight of the salt composition.

20. The food product of claim 15 wherein said first particle size is about 15 microns, said second particle size is about 220 microns, and said third particle size is about 75 microns.

21. A method of salting a food product comprising:
applying a salt composition to a food product, wherein said salt composition comprises a plurality of particles of sodium chloride having a bi-modal particle size distribution with a first peak at a first particle size and a second peak at a second particle size, wherein said first particle size is smaller than said second particle size; and a plurality of particles of at least one edible salt other than sodium chloride, having a particle size distribution comprising a third peak at a third particle size, wherein said third particle size is greater than said first particle size and smaller than said second particle size.

22. The method of claim 21 wherein said applying is at least one of dusting, topically applying, combining, and mixing.

23. The method of claim 21 wherein said particles of sodium chloride and said particles of at least one edible salt are applied in separate steps.

24. The method of claim 21 wherein said particles of sodium chloride and said particles of at least one edible salt are applied in a single step.

25. The method of claim 21 wherein said at least one edible salt comprises at least one of ammonium chloride, potassium chloride, calcium chloride, magnesium chloride, magnesium sulfate, and potassium sulfate.

26. The method of claim 21 wherein said edible salt comprises potassium chloride.

27. The method of claim 26 wherein said potassium chloride comprises about 33% by weight of the salt composition.

28. The method of claim 21 wherein said first particle size is about 15 microns, said second particle size is about 220 microns, and said third particle size is about 75 microns.
